(19) United States
(12) Patent Application Publication
(10) Pub. No.: US 2020/0328401 A1
(43) Pub. Date: Oct. 15, 2020

(54) PROCESS FOR HEAT TREATING A LITHIUM BATTERY

(71) Applicant: BLUE SOLUTIONS, Ergue--Gaberic (FR)

(72) Inventors: Margaud LECUYER, Combrit (FR); Vincent BODENEZ, Saint Yvi (FR); Philippe BERNARDO, Quimper (FR); Mathieu DRU, Briec (FR); Marc DESCHAMPS, Quimper (FR)

(73) Assignee: Blue Solutions, Ergue-Gaberic (FR)

(21) Appl. No.: 16/304,886

(22) PCT Filed: Jun. 7, 2017
(86) PCT No.: PCT/FR2017/051433

§ 371 Date: Nov. 27, 2018

(30) Foreign Application Priority Data
Jun. 8, 2016 (FR) 1655239

(51) Int. Cl. H01M 4/04; H01M 10/058; H01M 10/0525; H01M 10/0565; H01M 10/04; H01M 4/38; H01M 4/58

(52) U.S. Cl. CPC H01M 4/0471; H01M 10/058; H01M 10/0525; H01M 10/0565; H01M 2004/028; H01M 4/382; H01M 4/5825; H01M 2300/0082; H01M 10/0468

(57) ABSTRACT

The present invention relates to a process for decreasing the internal impedance of a lithium battery chosen from lithium-metal-polymer batteries and lithium-ion polymer batteries, said process comprising at least one first step consisting in raising said battery to a temperature T1 of at least 50° C., and at least one second step in which said battery is maintained for between 5 hours and 1 week at the temperature T1 while applying a pressure of at least 0.5 bar.

The present invention relates to the field of lithium batteries, in particular lithium-metal-polymer (LMP) batteries and lithium-ion polymer (Li—Po) batteries.

More precisely, the invention relates to a process for heat treating a lithium battery in order to optimize the performance thereof, both at the start of the life of the battery and more long-term.

Lithium batteries are particularly intended for motor vehicles and for grid energy storage.

LMP batteries generally take the form of an assembly of superposed thin films (roll or winding of n-turns of the following sequence {electrolyte/cathode/collector/cathode/electrolyte/anode}) or of n stacked thin films (that are cut and superposed, i.e. n stacks of the aforementioned sequence). This rolled/stacked unitary sequence has a thickness of about 100 μm. It is made up of four functional layers: i) a negative electrode (anode) that delivers lithium ions during the discharge of the battery; ii) a solid polymer electrolyte that is able to conduct lithium ions; iii) a positive electrode (cathode) that is composed of an active electrode material that acts as a receptacle into which the lithium ions intercalate; and lastly iv) a current collector that makes contact with the positive electrode and that makes electrical connection possible.

The negative electrode of LMP batteries generally consists of a sheet of lithium metal or of a lithium alloy; the solid polymer electrolyte is generally composed of a polymer based on poly(ethylene oxide) (PEO) and at least one lithium salt; the positive electrode is conventionally a material the working potential of which is lower than 4 V vs Li⁺/Li (i.e. the insertion/deinsertion potential of the lithium is lower than 4 V) such as for example a metal oxide (for example V₂O₅, LiV₃O₈, LiCoO₂, LiNiO₂, LiMn₂O₄ and LiNi_{0.5}Mn_{0.5}O₂, etc.) or a phosphate of LiMPO₄ type, where M is a metal cation selected from the group Fe, Mn, Co, Ni and Ti, or combinations of these cations (LiFePO₄ for example) and also contains carbon and a polymer; and the current collector generally consists of a sheet of metal. The conductivity of the ions is ensured by the dissolution of the lithium salt in the polymer component of the solid electrolyte.

Li—Po batteries are generally made up of a positive electrode of the same type as that of LMP batteries, a gelled polymer electrolyte comprising a polymer and a lithium salt in solution in a solvent, and a negative electrode made of a carbon-containing material such as graphite.

Lithium batteries, in particular LMP batteries, have a certain number of advantages.

Firstly, the specific power of LMP batteries is about 120 to 180 Wh/kg i.e. at least 2.5 times higher than that of the lead batteries of combustion cars (30-50 Wh/kg). Moreover, LMP batteries do not exhibit a memory effect and there is therefore no need to completely discharge them before recharging them, as is the case with certain other technologies (Ni—Cd). Lastly, for a voltage identical to those of lithium-ion batteries (about 3.4 V) LMP batteries require no maintenance and have a lifetime of close to 10 years, this being advantageous from a commercial point of view and making them appropriate for applications requiring electric traction.

Nevertheless, LMP batteries also have certain drawbacks. Specifically, to use them, they must be maintained at a temperature of about 60-80° C., this almost requiring that they be left charging plugged into the mains when the vehicle is not being driven. Otherwise, LMP batteries empty in a few days maintaining their temperature.

The internal resistance (also called internal impedance) of lithium batteries and in particular LMP batteries causes a voltage drop during discharge and limits performance in terms of power or self-heating. The internal resistance of a battery is defined as the opposition to the flow of current in a battery. This resistance has two main components: electronic resistance and ionic resistance. Their combined effect is called the total effective resistance. Electronic resistance encompasses the resistivity of the materials used, i.e. such as the metal of the cover, and internal components, but also parasitic resistances associated with the various interconnections forming the battery. Ionic resistance is the opposition to the passage of current in the battery due to various factors such as the ionic conductivity of the electrolyte and of the electrodes and the quality of the interfaces.

Internal resistance is generally low at the start of the life of the battery but tends to increase over the lifetime of the battery, this leading its performance to gradually decrease over the course of the many cycles of charging and discharging, until it reaches a value that is too high to allow it to continue to be used for the application for which it was initially designed. In general, the higher the initial internal resistance of a battery, the more its performance will be limited.

The initial internal resistance of a battery may be minimized by suitably choosing the raw materials used to form the electrodes and by improving the quality of the assembly.

For example, a process for decreasing the initial internal resistance of an LMP battery, consisting in over discharging said battery, i.e. in discharging the battery beyond 100% of its nominal capacity, for a sufficient amount of time to decrease its internal resistance, has already been proposed, in particular in patent application US 2014/019 7799. More precisely, the process consists in over discharging the LMP battery until it reaches a voltage comprised between 0.5 V and 2.0 V (second plateau), then in recharging said battery to its maximum capacity i.e. to a voltage of 3.6 V. It is indicated that this method allows the internal resistance of an LMP battery to be decreased by about 40%. However, this method is not entirely satisfactory in so far as the decrease in internal resistance is not necessarily uniform. Specifically, this method may lead to differences in resistivity between various zones of the battery, the over-discharge applied by this treatment not necessarily occurring with the same intensity in all of the elements making up the battery. Thus, this process is really effective only for batteries in which the active material is isotropically connected within the electrode at the moment when the over-discharge is carried out.

There is therefore a need for a process allowing the drawbacks of prior-art processes to be mitigated, and in particular for a process allowing the internal resistance (internal impedance) of lithium batteries, and in particular LMP and Li—Po batteries, to be significantly and durably decreased, both at the start of their life and long-term, this process being applicable to any type of LMP or Li—Po battery, especially to LMP and Li—Po batteries in which the nature of the positive-electrode active material is not limited, and in particular to batteries in which the connection of the positive-electrode active material is anisotropic.

This aim is achieved by the process that forms the subject matter of the present invention and that will be described below.

Therefore, the subject matter of the present invention is a process for heat treating a lithium battery chosen from lithium-metal-polymer batteries and lithium-ion polymer batteries, said battery including at least one positive electrode, at least one polymer electrolyte and at least one negative electrode, said process being characterized in that it comprises:

1) at least one first step consisting in raising said battery to a temperature T1 of at least 50° C.; and

2) at least one second step in which said battery is maintained at the temperature T1 while applying a pressure of at least 0.5 bar, the duration of said step 2) being from 5 hours to 1 week,

said steps 1) and 2) being carried out before the first charge of said battery.

The process according to the present invention allows the performance of LMP and Li—Po batteries to be improved. It is most particularly suitable for LMP batteries, and in particular leads:
to a decrease in the internal resistance of the LMP battery;
to an improvement in its power performance;
to an increase in energy;
to a decrease in activation effects at the start of the life of the battery;
to a longer lifetime.

According to the invention, by “significantly decrease internal resistance” what is meant is a decrease in the internal resistance of the battery at the end of step 2) of at least 2% with respect to the initial internal resistance, i.e. the internal resistance of the battery measured before the start of step 1) of the process according to the invention.

These advantages result from the effects of the heat treatment of the process according to the invention, which in particular engenders an optimization of the interfaces between the various layers of the battery and therefore a uniformization of the connection properties between grains of active material and an increase in the uniformity of the resistivity between the various zones of the battery. As indicated above, steps 1) and 2) are carried out before the first charge of said battery, i.e., directly after the positive electrode has been assembled with the polymer electrolyte and the negative electrode.

The temperature T1 is preferably from about 50 to 120° C., and even more preferably from about 70 to 105° C.

The battery may be raised to the desired temperature T1 using its own heating means or by hot storage.

In step 2), the pressure applied to the battery is preferably about 0.5 to 10 bars, and even more preferably about 1 to 7 bars.

The desired pressure may for example be applied to the battery using springs.

Step 2) is continued for enough time to significantly decrease the internal resistance of the LMP battery.

According to the invention, the duration of step 2) is preferably about 5 to 72 hours, and even more preferably about 5 to 25 hours.

The internal resistance of the battery before and after the process according to the invention has been applied may be measured by applying, to the terminals of the battery, an AC voltage of known amplitude and frequency and by measuring the resulting AC current and voltage. The internal resistance or internal impedance (Ri) may for example be calculated using Ohm's law from equation (1) below:

$$Ri = \frac{Δ U}{Δ I} \qquad ( 1 )$$

where:
ΔU is the variation in the potential between the rest state and the state under current; and
ΔI is the variation in the current made to flow at the start of discharge.

Thus, the internal-resistance values and measurements to which reference is made in the present application have been determined according to the method indicated below, and under the following conditions: the battery is subjected to a charging current of 8 A for 30 sec then left at rest. The difference between the voltage under current and the voltage measured at rest thus allows, via Ohm's law, the value of the internal resistance to be calculated.

These measurements do not affect the performance of the battery. They may be carried out when the battery is being used or be used to continuously monitor the variation in internal resistance, and therefore the performance of the battery during its various charge/discharge cycles.

Step 2) of the process according to the invention may either be carried out while leaving the voltage of the battery to fluctuate, or while imposing a set voltage value on said battery.

When step 2) is carried out under voltage, the voltage across the battery may for example be maintained constant at a voltage corresponding to the initial state of charge of said battery after its assembly, plus or minus 10% and preferably plus or minus 2%.

According to the invention, by “discharged battery”, what is meant is a battery that is discharged to more than 90% and preferably to more than 98% of its nominal capacity.

At the end of step 2), the battery may be used in a nominal manner.

According to one particular embodiment of the invention, it is possible for steps 1) and 2) of the process to be followed by an additional step of over discharging the battery.

Thus, according to this embodiment, the process according to the invention furthermore comprises a step 3) of over discharging said LMP battery. Although not obligatory, this additional step of over discharging allows the decrease in the internal resistance of the lithium battery obtained at the end of step 1) and 2) of the process according to the invention to be accentuated, most particularly in the case of LMP batteries.

In step 3) of over discharging, when it is carried out, the lithium battery is preferably discharged until the battery is discharged beyond 100% of its nominal capacity, in particular until the battery is over discharged by 2 to 40% of its nominal capacity and even more preferably by 8 to 20% of its nominal capacity.

Step 3) of over discharging may, for example, be carried out by applying to the battery an over discharging current of a size corresponding to a discharge regime of from about C/200 to C/10.

The process according to the invention may be applied to any type of lithium battery chosen from LMP batteries and Li—Po batteries, whatever the nature of the active material in the composition of the positive electrode material. It is however particularly suitable for LMP batteries and most particularly LMP batteries in which the active material of the positive electrode is chosen from iron phosphate and derivatives thereof, in particular LiFePO₄.

Thus, according to one particular preferred embodiment of the process according to invention, the battery is a lithium-metal-polymer battery having, by way of positive electrode material, iron phosphate LiFePO₄.

The present invention is illustrated by the following exemplary embodiments, to which it is however not limited.

### EXAMPLES

### Example 1: Preparation of a Unitary Cell of an LMP Battery and Demonstration of the Effect of the Heat Treatment According to the Process of the Invention on its Electrical and Physical Properties

In this example, the effect of the heat treatment according to the process of the invention on various properties of a unitary cell of an LMP battery has been studied, namely:
its thickness;
its internal resistance at the start of its life, with or without step 3) of over discharging;
its discharging profile;
its capacity at the start of its life.

Unitary LMP battery cells were prepared. Each of the unitary cells consisted of the superposition of 38 layers each containing:
a sheet of lithium metal (supplier Gangfeng);
2 polymer electrolyte films, on either side of the positive electrode;
a positive-electrode film, itself consisting of a current collector made of carbon-coated aluminium onto each side of which a positive-electrode material was laminated.

The polymer electrolyte was obtained by extruding a polymer blend (polyethylene oxide (PEO) (Zeospan) and poly(vinylidene fluoride co-hexafluoropropylene) copolymer (PVDF-HFP) (Solvay)) and a lithium salt (lithium bis(tetrafluorosulfonyl imide), LiTFSI, 3M) in proportions by weight of 48/40/12.

The positive electrode material was obtained by extruding and laminating a mixture of lithium iron phosphate (LiFePO₄) (Pulead, unless otherwise specified), of an ethylene oxide/butylene oxide copolymer P(OE-OB) (Nippon Shokubai), and of LiTFSI (3M) in proportions by weight of 68/24/6, and of 2% carbon (Ketjen black), on either side of a current collector made of aluminium coated with a carbon-containing protective layer (ARMOR).

Then, each of the unitary cells was obtained by juxtaposing each of the films obtained beforehand.

The internal resistance of the cells tested in this example was measured at the start of discharge during cycling, by applying the follow

$$Ri = \frac{Δ U}{Δ I}$$

where ΔU is the variation in potential between the rest state and the state under current and ΔI is the variation in the current made to flow at the start of discharge.

### 1.1 Measurements of the Effect of the Heat Treatment on the Thickness of the Cell

The thickness of the un-cycled unitary cell was measured before and after a thermal cycle comprising the following 3 steps:

1) an increase in temperature, from room temperature to 80° C.;

2) maintenance at the temperature of 80° C. for 48 hours, the cell also being subjected to a pressure of 2 bars;

3) natural cooling of the cell to room temperature.

A compression of the thickness of the cell of 140 μm was observed at the end of the thermal cycle. The cell being in the same state of charge and at the same temperature as the initial state, i.e. before the thermal cycle had been performed, this thickness variation was attributed to an optimization of the interfaces during this heat treatment.

### 1.2. Effects of the Heat Treatment on the Variation of the Internal Resistance at the Start of Life without a Step of Over Discharging

Two unitary cells of identical composition and such as described above were heated until a temperature of 80° C. was reached.

One of these two cells was then immediately cycled (C/8 D/2 cycling) (comparative cell C′1, process not according to the invention), whereas the other cell underwent beforehand a step in which it was maintained at 80° C. for 72 hours, under a pressure of 2 bars, according to the process according to the invention (cell C1 according to the invention).

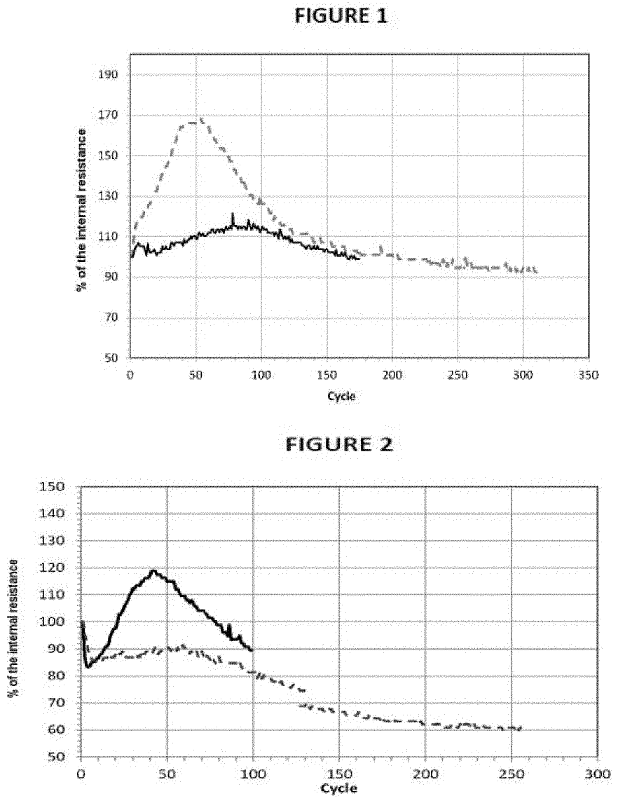

Appended FIG. 1 shows the variation in the internal resistance (in %) of each of the cells as a function of the number of cycles. In this figure, the variation in the internal resistance of the cell C′1 not according to the invention corresponds to the curve drawn with the discontinuous line and that of cell C1 according to the invention corresponds to the curve drawn with the continuous line.

These results show that the heat treatment allows the internal resistance of the cell C1 under cycling to be stabilized (increase of only about 15% during the first 100 cycles) with respect to that of the cell C′1, which in contrast sees an increase of about 70% in its internal resistance over the first 100 cycles. The heat treatment therefore allows the repeatability of the behaviour of the cell over its life to be improved while minimizing the increase in the internal resistance under cycling.

### 1.3. Effects of the Heat Treatment with a Step of Over Discharging on the Variation in the Internal Resistance at the Start of Life and on the Variation in Capacity

Two unitary cells of identical composition and such as described above were heated until a temperature of 80° C. was reached.

One of the two cells then underwent a step of over discharging at 3 A for 3 h 20, then cycled (C/8 D/2) (cell C′2 obtained according to a process not according to the invention).

The other cell first underwent a step in which it was maintained at 80° C. for 72 hours, under a pressure of 2 bars, before in turn undergoing a step of over discharging at 3 A for 3 h 20, then cycling (C/8 D/2) (cell C2 obtained according to the process according to the invention).

Appended FIG. 2 shows the variation in the internal resistance (in %) of each of the cells as a function of the number of cycles. In this figure, the variation in the internal resistance of the cell C′2 not according to the invention corresponds to the top curve and that of the cell C2 according to the invention corresponds to the bottom curve.

These results show that the heat-treatment step according to the process according to the present invention allows the increase in the internal resistance observed in the first 40 cycles of the cell C2 to be greatly limited.

In addition, it may be seen that the internal resistance of the cell C2 is lower than that of the cell C1 having undergone a heat treatment according to the process according to the invention but not having undergone the optional step of over discharging (see FIG. 1). These results confirm that the step of over discharging, although optional, allows the properties of the cells to be even further improved, in particular by decreasing the internal resistance of the battery at the start of its life.

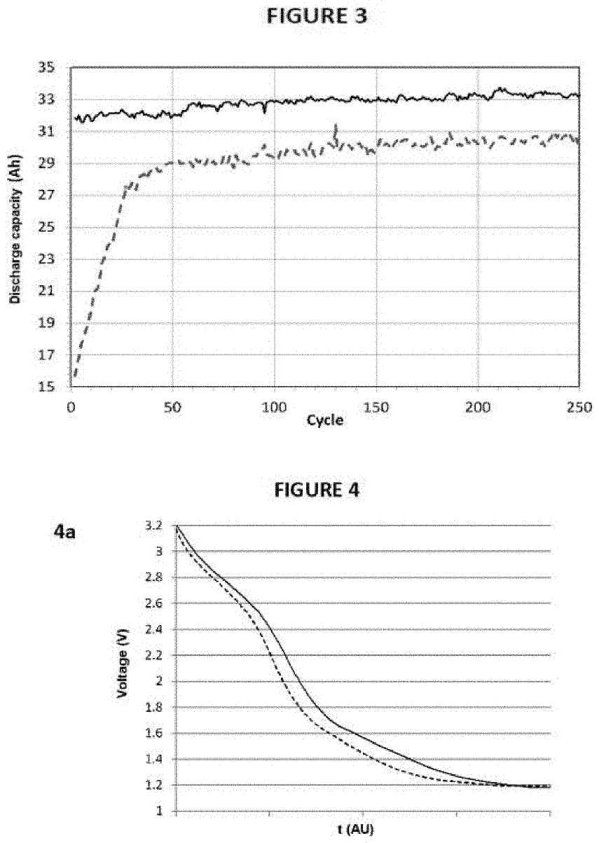

Moreover, appended FIG. 3 gives the results of the variation in the capacity obtained at D/2, for the two cells C′2 and C2, as a function of number of cycles. In this figure, the discharged capacity (in Ah) is a function of number of cycles; the top curve corresponds to the cell C2 having undergone the treatment process according to the invention whereas the bottom curve corresponds to the cell C′2 not having undergone such a treatment.

The results presented in FIG. 3 show that the heat treatment prior to the over-discharge of the cell obtained according to the process of the invention (C2) allowed, from the very first cycles, an optimal cell performance to be achieved.

### Example 2: Preparation of an LMP Battery Composed of a Plurality of Unitary Cells and Demonstration of the Effect of the Heat Treatment According to the Process of the Invention on its Physical and Electrical Properties

In this example, the impact of a heat treatment according to the process according to the invention on the performance of an LMP battery composed of 120 unitary cells mounted in series (i.e. a pack) was evaluated. Each unitary cell (or module) composing the LMP battery had the same composition as that of the unitary cells used above in the tests presented in Example 1.

Two protocols were applied to 2 identical batteries:

Protocol 1 according to the invention:
Heating of the battery from room temperature to 80° C.;
Heat treatment: regulation and maintenance at 86° C. for 18 hours and under a pressure of 2 bars for each of the cells;
Over-discharge at 3 A.

Thus a battery LMP1 according to the present invention was obtained.

Protocol 2 NOT according to the invention:
Heating of the battery from room temperature to 80° C.;
Over-discharge at 3 A.

Thus a battery LMP2 not according to the present invention was obtained.

The performance of each of the batteries LMP1 and LMP2 was characterized by a cycle of discharging (D/4) and charging (C/10).

The improvements in terms of energy, max/module resistance and total resistance (pack) for the battery LMP1 according to the invention were calculated with respect to the values measured for each of these parameters on the battery LMP2 not according to the invention.

The results obtained are given in Table 1 below:

TABLE 1

| | | Decrease in | Decrease |
|---|---|---|---|
| | Increase in | max/module | in pack |
| Battery | energy | resistance | resistance |
| LMP1 | +8% | −4% | −3% |

The treatment protocol according to the invention, i.e. including a step of maintaining the battery at the temperature of 86° C. for 18 hours, allowed both an increase in energy and a decrease in internal resistance to be obtained, both at the level of a unitary cell of the battery and at the whole-battery level.

The voltage profile of the over-discharge of each of the batteries LMP1 and LMP2 is shown in appended FIG. 4. In FIG. 4a, the voltage (in V) is a function of time (t in arbitrary units: AU) and in FIG. 4b the derivative of the profile of FIG. 4a dt/dV (in s·V⁻¹) is a function of voltage (in V). In FIGS. 4a and 4b, the curves drawn with the discontinuous lines correspond to the results for the battery LMP1 according to the invention, whereas the curves drawn with the continuous lines correspond to the results of the battery LMP2 not according to the invention

The results presented in FIG. 4 show that the various shoulders are more marked for the battery LMP2 not having undergone the heat treatment according to the process according to the invention than for the battery LMP1 having undergone it. This is made clearer by taking the derivative of the curve level with the shoulder located at about 1.4 V.

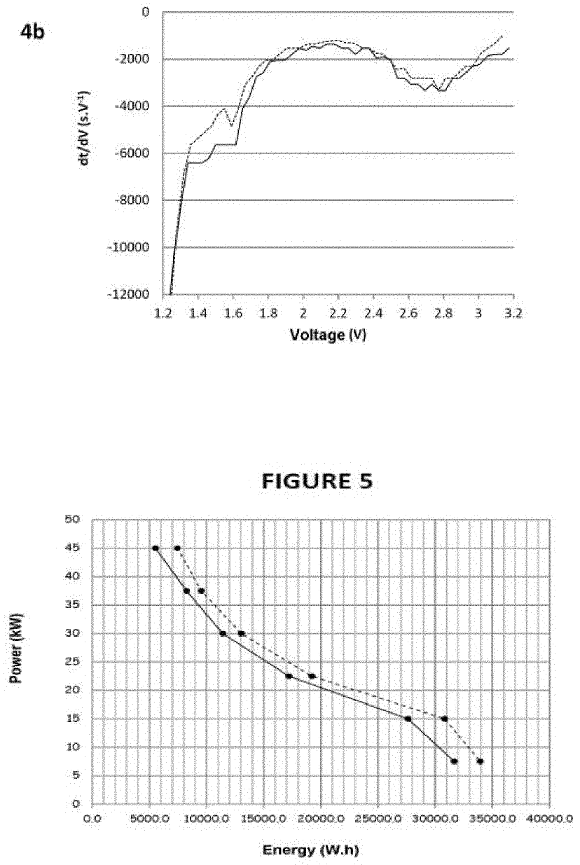

Appended FIG. 5 shows the Ragone chart of the batteries LMP1 and LMP2. In this chart, the power (in kW) is a function of energy (in W·h). In this figure, the curve drawn with the discontinuous line corresponds to the battery LMP1 according to the invention and the curve drawn with the continuous line corresponds to the battery LMP2 not according to the invention.

The same experiment was carried out on a strictly identical battery, but while carrying out the heat treatment at a temperature of 70° C. for 18 hours instead of 86° C. A battery LMP1′ also according to the invention was obtained.

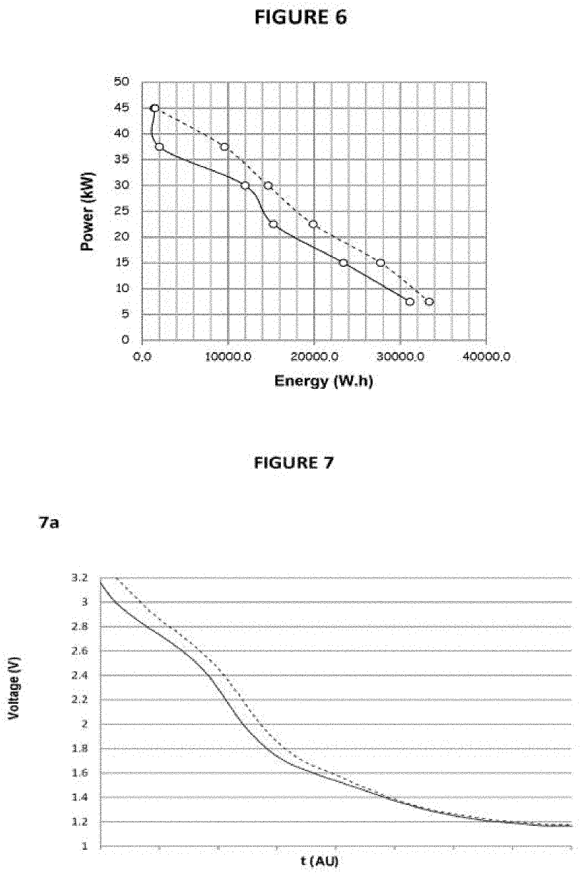

Appended FIG. 6 shows the Ragone chart of the batteries LMP1′ and LMP2. In this chart, the power (in kW) is a function of energy (in W·h). In this figure, the curve drawn with the discontinuous line corresponds to the battery LMP1′ according to the invention and the curve drawn with the continuous line corresponds to the battery LMP2 not according to the invention.

The Ragone charts of FIGS. 5 and 6 reveal that the heat treatment according to the process according to the invention is advantageous under all discharging regimes. The differences between the battery having or not having undergone a heat treatment protocol according to the process according to the invention are increasingly marked as temperature decreases (see FIG. 6).

### Example 3: Preparation of an LMP Battery Composed of a Plurality of Unitary Cells and Demonstration of the Effect of the Heat Treatment According to the Process of the Invention on its Physical and Electrical Properties

In this example, the impact of a heat treatment under voltage according to the process according to the invention on the performance of an LMP battery composed of 120 unitary cells mounted in series (i.e. a pack) was evaluated. Each unitary cell (or module) composing the LMP battery had the same composition as that of the unitary cells used above in the tests presented in Example 1.

Two protocols were applied to 2 identical batteries:

Protocol 3 according to the invention:
Heating of the battery from room temperature to 80° C.;
Heat treatment: maintenance at a constant voltage of 3.3 V for 15 hours with regulation of the temperature to 80° C., under a pressure of 2 bars on each of the cells;
Over-discharge at 3 A.

Thus a battery LMP3 according to the present invention was obtained.

Protocol 4 NOT according to the invention:
Heating of the battery from room temperature to 80° C.;
Over-discharge at 3 A.

Thus a battery LMP4 not according to the present invention was obtained.

The performance of each of the batteries LMP3 and LMP4 was characterized by a cycle of discharging (D/4) and charging (C/10).

The improvements in terms of energy, max/module resistance and total resistance (pack) for the battery LMP3 according to the invention were calculated with respect to the values measured for each of these parameters on the battery LMP4 not according to the invention.

The results obtained are given in Table 2 below:

TABLE 2

| | | Decrease in | Decrease |
|---|---|---|---|
| | Increase in | max/module | in pack |
| Battery | energy | resistance | resistance |
| LMP3 | +15% | −2% | −3% |

These results show that the heat treatment of the battery carried out when the latter is under voltage also allows a significant improvement in the performance of the battery to be achieved.

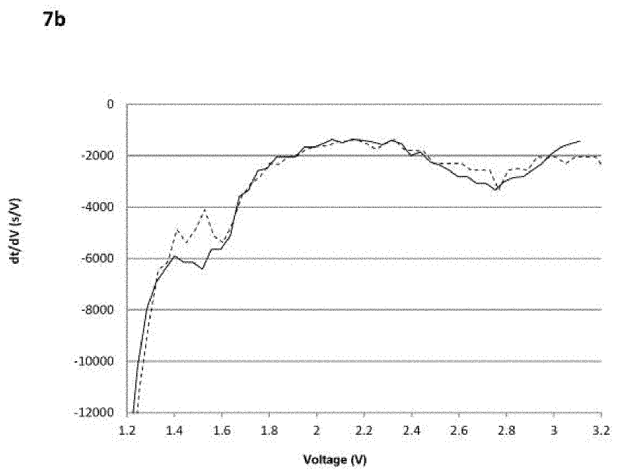

The voltage profile of the over-discharge of each of the batteries LMP3 and LMP4 is shown in appended FIG. 7. In FIG. 7a, the voltage (in V) is a function of time (t in AU) and in FIG. 7b the derivative of the profile of FIG. 7a dt/dV (in s·V⁻¹) is a function of voltage (in V). In FIGS. 7a and 7b, the curves drawn with the discontinuous lines correspond to the results for the battery LMP3 according to the invention, whereas the curves drawn with the continuous lines correspond to the results of the battery LMP4 not according to the invention.

The results presented in FIG. 7 show that the various shoulders are more marked for the battery LMP4 not having undergone the heat treatment under voltage according to the process according to the invention than for the battery LMP3 having undergone it. This is made clearer by taking the derivative of the curve level with the shoulder located at about 1.4 V.

1. Process for heat treating a lithium battery chosen from lithium-metal-polymer (LMP) batteries and lithium-ion polymer batteries, said battery including at least one positive electrode, at least one polymer electrolyte and at least one negative electrode, said process comprising the steps of:
1) at least one first step consisting in raising said battery to a temperature T1 of at least 50° C.; and
2) at least one second step in which said battery is maintained at the temperature T1 while applying a pressure of at least 0.5 bar, the duration of said step 2) being from 5 hours to 1 week, said steps 1) and 2) being carried out before the first charge of said battery.

2. Process according to claim 1, wherein the temperature T1 is from 50 to 120° C.

3. Process according to claim 1, wherein the temperature T1 is from 70 to 105° C.

4. Process according to claim 1, wherein in step 2), the pressure applied to the battery is from 0.5 to 10 bars.

5. Process according to claim 1, wherein in step 2), the pressure applied to the battery is from 1 to 7 bars.

6. Process according to claim 1, wherein the duration of step 2) is from 5 to 72 hours.

7. Process according to claim 1, wherein the duration of step 2) is from 5 to 25 hours.

8. Process according to claim 1, wherein step 2) is carried out under voltage and in that the voltage across the battery is maintained constant at a voltage corresponding to the initial state of charge of the battery after its assembly plus or minus 10%.

9. Process according to claim 1, wherein step 2) is carried out under voltage and in that the voltage across the battery is maintained constant at a voltage corresponding to the initial state of charge of said battery after its assembly plus or minus 2%.

10. Process according to claim 1, wherein said process furthermore comprises a step 3) of over discharging said battery.

11. Process according to claim 10, wherein said process is applied to an LMP battery.

12. Process according to claim 10, wherein, in step 3) of over discharging, the battery is discharged until it is over discharged by 2 to 40% of its nominal capacity.

13. Process according to claim 10, wherein, in step 3) of over discharging, the battery is discharged until it is over discharged by 8 to 20% of its nominal capacity.

14. Process according to claim 10, wherein step 3) of over discharging is carried out by applying to the battery an over-discharge current corresponding to a discharge regime of from C/10 to C/200.

15. Process according to claim 1, wherein the lithium battery is an LMP battery in which the active material of the positive electrode is chosen from iron phosphate and derivatives thereof.
